(19) United States
(12) Patent Application Publication
(10) Pub. No.: US 2003/0081002 A1
(43) Pub. Date: May 1, 2003

(54) Method and system for chaining and extending wizards

(75) Inventors: David George De Vorchik, Seattle, WA (US); David Joel Sheldon, Seattle, WA (US)

Correspondence Address: Scott B. Strohm, SHOOK, HARDY & BACON L.L.P., 1200 Main Street, Kansas City, MO, 64105-2118, US

(73) Assignee: Microsoft Corporation

(21) Appl. No.: 10/015,958

(22) Filed: Oct. 30, 2001

(51) Int. Cl. G09G 5/00

(52) U.S. Cl. 345/762; 345/737

(57) ABSTRACT

The present invention provides a system and method that allows software developers to more effectively chain and extend wizards. Using this method, a software developer will indicate within the software code, access points or those stages in the process where an external wizard or HTML pages could be incorporated. Furthermore, a developer can also create reusable parts of a wizard (sub-wizard) that can be incorporated into other wizards (host-wizard), thus allowing the extension of the host-wizard. Sub-wizards can be component objects and/or contain HTML pages from the Internet or other sources. A host-wizard and one or more sub-wizards can exchange information and pass control through the specification of certain object functions and a ‘property bag’. A ‘property bag’ can be thought of as an assorted collection of miscellaneous data, variables and other information that a developer needs to exchange between wizards.

### STATEMENT REGARDING FEDERALLY-SPONSORED RESEARCH OR DEVELOPMENT

None.

### CROSS-REFERENCE TO RELATED APPLICATIONS

None.

### TECHNICAL FIELD

The present invention relates to software program modules. More particularly, the invention relates to a system and method for extending application wizards or other similar programs that provide assistance to a user through a series of prompts, which are intended to aide the user in completing a task.

### BACKGROUND OF THE INVENTION

Despite the best efforts of software developers or software designers, software programs inevitably require the end user to perform certain configuration tasks or more commonly, the user needs assistance in performing particular tasks or functions using the software program. Conveying information to the user on how to accomplish a given task or function of the software program usually requires some instructions and guidance.

Historically, user manuals and more recently online help information coupled with training programs, have been utilized as the method for aiding the user community in navigating through application or configuration tasks. Typically, the most helpful user instructions are in the form of manuals or online help, which tend to have very specific step-by-step instructions. These user instructions also include visual representations of the computer screens that would be seen by the user at each step of the instructions. The level of detail that is found in these meticulous user instruction guides is directly proportional to the degree of pleasurable user experience. However, the down side to such detailed guides is the time and effort required to put together detailed and elaborate help manuals or online help systems. This is particularly the case when such manuals or systems may or may not totally address the needs of the user or alleviate the tedium experienced by the user when performing certain tasks. Furthermore, programmed user guides need to be designed to anticipate the effect of external factors that may influence the response of the computer system or application, such as abnormal key press or user selections.

Wizard applications were developed to address the problems associated with user guides while still providing the underlying functionality. A wizard specifically directs a user through a configuration process or the implementation of a particular task within an application program. A wizard is essentially a programmatic method of providing guidance to a user, within a controlled environment and in a predictable manner. This alleviates problems that are encountered by a user that is unfamiliar with the program environment. A wizard also facilitates the accomplishment of certain critical or mundane and repetitive tasks. Another wizard definition is a multi-step process that is controlled by a user's navigation of screens in order to answer questions and ultimately complete an operation. Screen navigation is typically accomplished using next and back buttons. A wizard is constructed from a series of dialog boxes, templates, text, and programmed code that respond to user selections. The dialog boxes are passed to procedure frameworks, which display the wizard pages in the order that they were created, or in an order that is defined by the backing programmed code. Certain portions or the entire functions of a particular wizard can be utilized with multiple software applications or with various system configuration needs because of a wizard's broad base applicability to the computing environment.

This concept of extensibility or reusability of a wizard is similar to the use of certain operating system functions within application programs. For instance, file access on a computer system is a function that is typically required and is usually one of several functions that are performed by a particular computer program. For example, an application that obtains a user name and writes that information to a user specified file, will need to generate a screen to prompt the user and accept the user entry in addition to requiring file access. File access will be required in order for the application to provide the user with a list of existing directories and files, so that the user can specify where the new information should be stored. In the Microsoft Windows environment, a file dialog object is available to any programmer that writes an application that will be accessing files. The file dialog object saves the programmer the time involved with writing required file access routines, developing a specific user interface for the file operations and so on. In addition, the availability of this dialog, which is used by a majority of Windows programs, also provides an interface that is familiar to the user community, thus providing another added benefit to the programmer i.e. user friendliness. As such, in the aforementioned exemplary user name writing application, the programmer can utilize the standard file dialog object coupled with his prompt screen. The programmer will in effect get the benefits of the file dialog object without the tedium involved in developing the dialog from scratch. The nature of the file dialog is such that the programmer could also extend its functionality, by causing other events to occur in conjunction with the use of the dialog object.

In much the same way as the file dialog, there is a need to be able to incorporate a wizard or portions thereof, into other wizards. There is also a need to extend the functionality of application or program wizards in order to provide more robust and customizable features. All of these capabilities would improve performance and user experience among other things.

The benefits to be derived from the reusability of wizards and the ability to extend wizards, underscore the need for a method and system that make such features available. There is also a further need for a method and system to allow developers to author wizards that can be incorporated into other wizards and wizards that support extensions. In addition to the previously mentioned functionality, there is also a need to seamlessly utilize HTML pages from an internet or intranet site, in conjunction with a traditional wizard application that is executing on a personal computer, thus allowing greater flexibility in the operations and utilization of wizards. In other words, a wizard application should be able to utilize some traditional dialog type object pages and some web pages in a manner that it is transparent to the user while also providing the developer with flexibility in coding.

### SUMMARY OF THE INVENTION

The present invention provides a method and system for use on a computer system for chaining and extending wizards in an abstract form thus allowing third parties to develop extensions to existing wizards. The present invention further provides a protocol for handling navigation between screens of multiple wizards and components. In the present invention, a multi-step user interface host component, otherwise referred to as a host-wizard, has the ability to invoke one or more multi-step user interface sub components, otherwise referred to as sub-wizards during the execution of the host-wizard. Furthermore, the present invention provides a method to chain multiple wizards by providing at least one navigation component on each of multiple wizards, where the navigation components allowing sequential progression or regression between the different wizards. In addition, the invention also provides a method for the integration of HTML pages into wizards as such, chained wizards could be any combination of traditional operating system based wizards and HTML based wizards.

Additional advantages and novel features will be set forth in the description which follows and in part may become apparent to those skilled in the art upon examination of the following, or may be learned by practice of the invention.

### BRIEF DESCRIPTION OF THE SEVERAL VIEWS OF THE DRAWING

The present invention is described in detail below with reference to the attached drawings figures, wherein:

FIG. 1 is a block diagram of a computing system environment suitable for use in implementing the present invention;

FIG. 2 is a schematic view illustrating a flow of the present invention;

FIG. 3 is a schematic view illustrating screen flows in a typical wizard application; and

FIG. 4 is an illustrative a screen of a web page and frames that can be utilized with the present invention.

### DETAILED DESCRIPTION OF THE INVENTION

The present invention provides a system and method that allows software developers to more effectively chain and extend wizards. Using this method, a software developer will indicate within the software code, access points or those stages in the process where an external wizard or HTML pages could be incorporated. Furthermore, a developer can also create reusable parts of a wizard (sub-wizard) that can be incorporated into other wizards (host-wizard), thus allowing the extension of the host-wizard. Sub-wizards can be component objects and/or contain HTML pages from the Internet or other sources. A host-wizard and one or more sub-wizards can exchange information and pass control through the specification of certain object functions and a ‘property bag’. A ‘property bag’ can be thought of as an assorted collection of miscellaneous data, variables and other information that a developer needs to transfer between wizards.

Having briefly described an embodiment of the present invention, an exemplary operating environment for the present invention is described below.

Exemplary Operating Environment

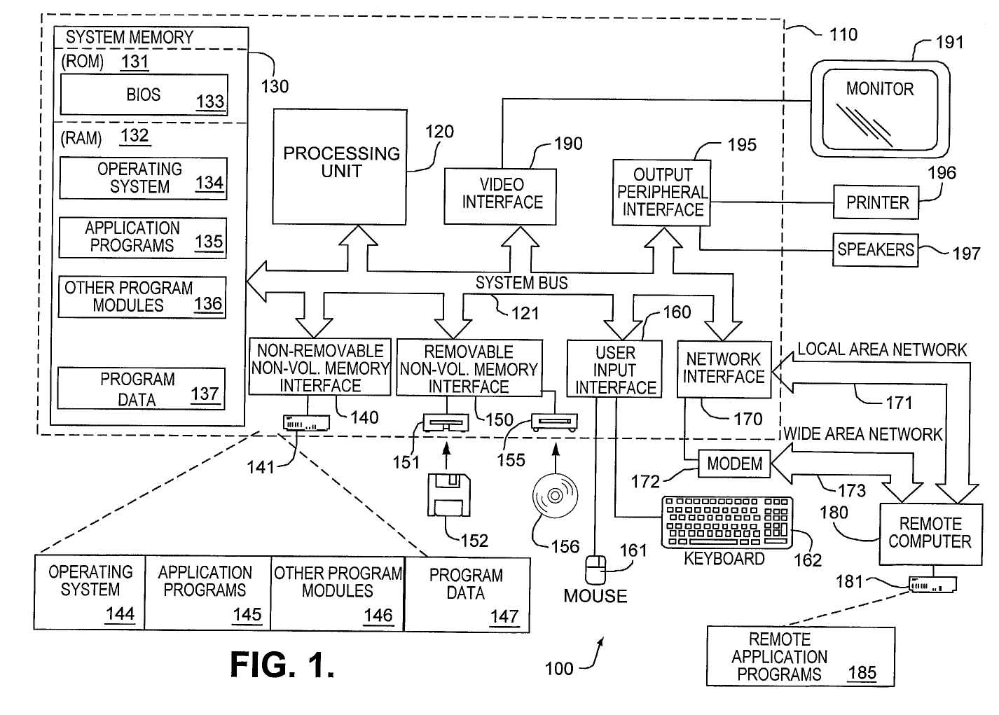

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with a variety of computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

System for Extending Wizards

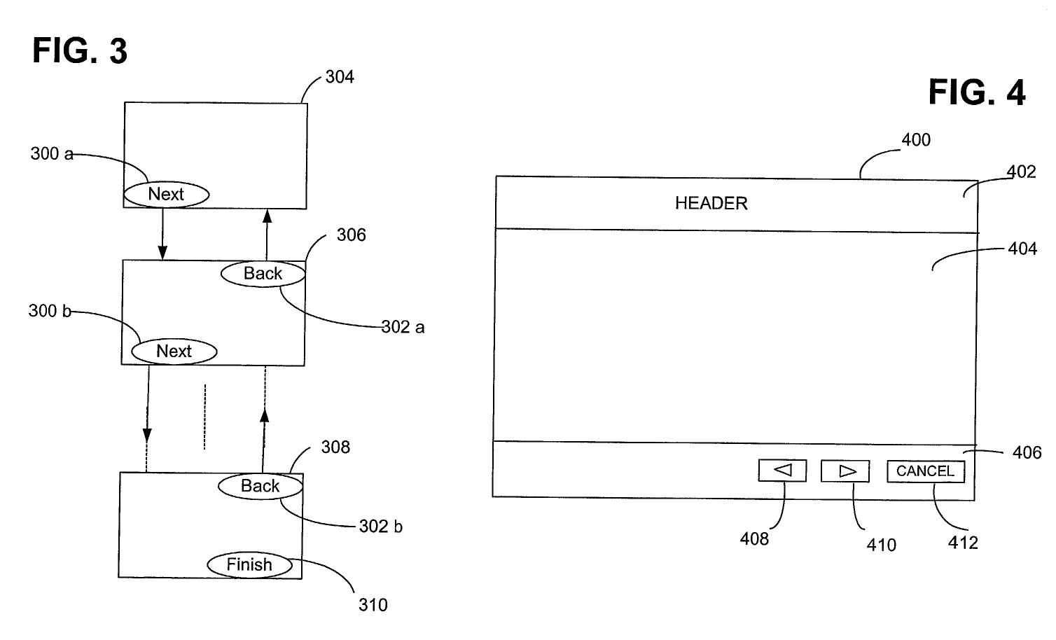

The present invention provides, among other things, a system that allows software developers to more effectively provide user assistance and direction. Referring to FIG. 3, a broad view and flow of the use of a wizard is illustrated. The process and flow of a typical wizard consists of several wizard pages and a means for navigation between the pages, as shown. By way of example and not limitation, a wizard may comprise a start page 304, a series of one or more other transitional pages 306 and a final page 308. As will be discussed in further detail, each of the wizard pages also contains one or more buttons that enable recursive navigation to and between other pages, while also providing communications to a wizard application program. The wizard application program is the software program code that executes behind the scene to implement or direct the actions of a user.

The start page 304 of a wizard may have in addition to the other information and objects on the page, such as dialog boxes, text and buttons, a next-button 300a. The next-button 300a, provides the means for navigation from the start page 304 to the next page in the sequence, in this case transitional page 306. In addition, the next-button 300a also signals the wizard application program by indicating the completion of the stage of the program that is associated with the start page 304. Furthermore, the next-button 300a also indicates the desire of a user to proceed to the next page and stage of the wizard program.

The final page 308 of a wizard may also have in addition to the other information and objects on the page, such as dialog boxes, text and buttons, a back-button 302b and a finish-button 310. In a similar manner to the next-button 300a of the start page, the back-button 302b provides navigation to the previous page of the wizard and directs the wizard program to return to the previous stage of the program. Generally, any information that was provided by a user on the previous page would again be displayed when the back-button 302b returns focus to that page. In effect, the back-button 302b allows the user to review or edit any information that was previously provided. The finish-button 310, which is unique to the final page 308, allows a user to indicate the completion of the user interactive portion of a wizard program. A page or screen change may occur in conjunction with the selection of the finish-button 310 and any additional processing to be performed by the wizard application would begin upon this user indication.

The transitional pages 306, of which there could be several, come between the start page 304 and the final page 308. In addition to the other information and objects on a transitional page 306 such as dialog boxes, text and buttons, there is also a next-button 300a and a back-button 302b. As previously discussed the next-button 300a provides navigation to the next page in the sequence i.e. another transitional page 306 or the final page 308. The back-button 302b provides navigation to previous pages i.e. another transitional page or the first page 304, depending on the relative position of the transitional page 306.

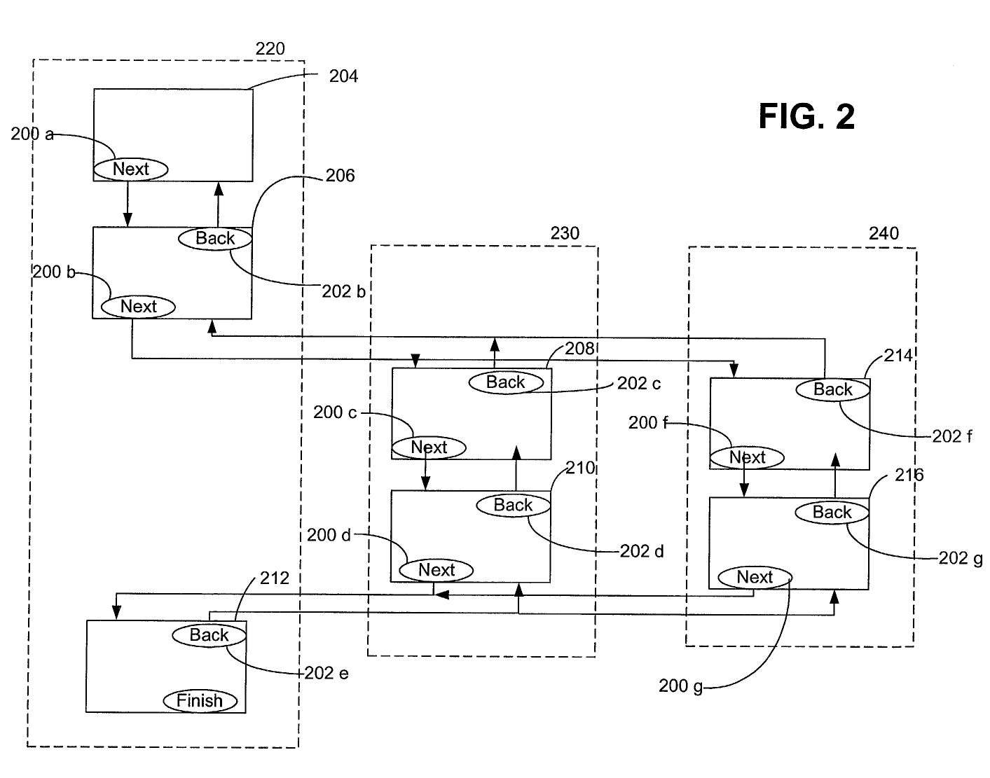

Having discussed the typical operation of a wizard, we turn next to an explanation of an extensible wizard and a wizard that can be utilized by multiple wizard programs as an added component. In other words, the present invention allows the pages from a first wizard application, written as a sub-wizard, to be re-used in one or more other wizard applications, written as host-wizards. FIG. 2 illustrates the flow and interaction of pages from multiple sub-wizards, which are component extensions and a host wizard. For the purpose of explaining how the present invention operates, a host-wizard application 220, a first traditional object component wizard extension 230 and a second HTML based component wizard extension 240, along with their constituent pages and buttons are illustrated. It will be understood by those skilled in the art that the discussion with respect to FIG. 2 is provided as an exemplary illustration and should not be considered a limitation. The details of the distinction between a traditional component wizard extension 230 and the HTML component wizard extension 240 will be discussed later in this document. Unless otherwise specified within this document, any reference to a component wizard is equally applicable to either the HTML type 240 or traditional object component type 230 of wizard extension.

A component wizard 230, 240 has one or more pages or screens that allow recursive navigation in much the same way that any wizard application does. A component-wizard can be described essentially as a reusable collection of pages and code that can be seamlessly plugged into a wizard to perform a set of operations. A component wizard must be able to handle the next and back features of a wizard. A host wizard application can be created to accept one or more component-wizards as plug-ins. Details on how component-wizards are created and utilized will be discussed later in this document.

Turning to FIG. 2, a host-wizard application 220 with the ability to support either one of the component-wizards 230, 240 as a plug-in is illustrated. The host-wizard 220 has a first-page 204 with a next-button 200a that provides navigation to a subsequent transitional page 206 in the wizard sequence. Transitional page 206 has a back-button 202b that allows a user to navigate back to the first page 204. In addition, the transitional page 206 has a next-button 200a that would normally provide navigation to a subsequent page. However, an embodiment of the present invention provides a method wherein the next-button 200b of the host-wizard 200 navigates to the first page 208, 214 of the component-wizards 230, 240. The details of how this is accomplished will be discussed with reference to examples of some specific programming object modules and functions. As would be understood by those skilled in the art, the requirements and types of the object modules or functions may vary between traditional object wizard-component 230 and the HTML wizard-component 240.

When navigation to a component wizard 230, 240 has occurred, all subsequent navigation and information processing is conducted by the wizard program of the component 230, 240 extension rather than the program of the host-wizard 220. In other words, all control is passed to the component. Because the component is also a wizard, it too has pages that utilize and respond to back-buttons and next-buttons. As shown, the component wizard extension 230 has a transitional page 208 which contains a back button 202c and a next-button 200c. Back-button 202c causes navigation and control to pass back to the host-wizard 220. In particular, the navigation back to the host-wizard causes the host's transitional page 206 to be displayed and places the host wizard program at the stage associated with that page. Next-button 200c on the transitional page 208 of the component wizard extension 230 causes the subsequent transitional page 210 of the extension to be displayed and advances the component wizard program to the associated stage. In contrast, the next-button 200d of the transitional page 210 causes the component wizard program to complete its operations, in much the same way as a finish button on any wizard. The next-button 200d also causes the component wizard program to hand off control and to navigate to the sequential page of the host wizard, which in this case happens to be the final page 212 of the host-wizard 220. As discussed earlier with respect to other wizard pages, there is a back-button 200e on the final-page 212 of the host-wizard 220. The back-button 200e not only navigates back to the final page 210 of the component wizard 230, it also transfers control to the component wizard program. As can best be seen in FIG. 2, another wizard-component 240 could just as easily be substituted for the wizard-component 230 and it will operate in much the same way, as long as the back-button 202f and the next-button 200g appropriately navigate and transfer control to the host wizard application 220.

Although the incorporation of a traditional object component wizard extension and an HTML component wizard extension into a host wizard are similar, and the user experience with regards to either extension are also similar, there are some distinct dissimilarities. Apart from the obvious differences in the operating environment and in the creation process of the extensions, there are some subtle differences in the underlying operation within the two types of extensions. In order to more fully explain the characteristics of each component type, a discussion on the creation and utilization of these components within an exemplary operating environment is provided.

For the purpose of illustration and not limitation, the present invention will be described in terms that are suggestive of object based computer coding. Those of ordinary skill in the art will appreciate that other implementations are available and well within the scope of the present invention. In order for a host wizard application to support component extensions, the host application must define and expose an interface. As such, for the purpose of this discussion a host-wizard developer will define an object IWizardHost, which would have among other things a GetCancelledPage, a GetPreviousPage and a GetNextPage event, all of which can be called by a component wizard program. As implied by the event names, each of these events is initiated by a component wizard extension in order to navigate to the appropriate page of the host-wizard. Turning back to FIG. 2, in the case of the GetPreviousPage event, the back-button 202c of the component wizard 230 initiates this event in order to return to what would have been the departing page of the host, i.e. the host-wizard page 206, which immediately preceded the first page 208 of the component wizard 230. In the case of GetNextPage event, the next-button 200d of component wizard extension 230 initiates the event in order to navigate to the next sequential page 212 of the host wizard 220. GetCancelledPage allows an extension to query the site for the page it should navigate to when the user initiates a Cancel on the host. This is important for transaction operations where further user interaction is required to explain the changes that are being rolled back.

A component wizard extension developer must also define an object to allow access to its pages. This component extension object is IWizardExtention. IWizardExtension has events such as AddPages, GetFirstPage and GetLastPage events, which are also accessible to the host-wizard program. In addition, on the component side, the creation of an IWizardExtension also initiates the creation of an IObjectWithSite and an IObjectSetSite object. IObjectWithSite is a pointer to the creating component object and IObjectSetSite is a pointer to the intended host object. As implied by the named, AddPages event allows a host-wizard to indicate a desire to add the pages of a component wizard extension. GetFirstPage event is activated by the next-button of the host-wizard at the desired point of insertion. For example, returning to FIG. 2, the next-button 200b of host-wizard page 206 would call GetFirstPage of the component wizard extension 230, which will cause the activation of the first component page 208. GetLastPage on the other hand, is called by the host-wizard page that immediately follows the last page of the component wizard extension. In other words, the back-button 202e of host-wizard page 212, would call the GetLastPage event of the component wizard extension 230 in order to navigate back to the component wizard page 210.

In the case of an HTML component wizard extension otherwise referred to as a Web Wizard Extension(WWE), the object that is created to allow access to the HTML extension is IWebWizardExtension, which is itself an extension of the IWizardExtension. In software development terms, IWebWizardExtension is a derived object of IWizardExtension. IWebWizardExtension includes a unique property called SetInitialURL, which holds the Universal Resource Locator (URL) of the web page to be displayed. IWebWizardExtension supports the events GetFirstPage and GetLastPage, however unlike the component wizard extension versions, both events return the same web page. In the case of WWE, a single web page with a fixed header, control area and wizard display area provides the effect of having several component pages. FIG. 4 illustrates a WWE screen. As shown, there is a single page 400, with a header 402 and a common wizard control interface 406, where the controls for navigating through the various screens can be found. A back-button 408 allows navigation to the previous screen in the wizard. A next-button 410 allows navigation to the next screen in the wizard and a cancel-button 412 allows a user to exit the wizard application. It should be noted that the navigation buttons 410,412 provide navigation without regard to whether the next page in the sequence is a WWE page or a host-wizard page. A wizard program controlled area 404 provides the different pages for the WWE. In other words what a user perceives as being different screens on pages of the WWE, are really just variations of the information displayed in the controlled area 404 on the same page 400. In order to function in a consistent manner with the rest of the wizard applications, the HTML page of WWE has a script that provides support for the OnNext, OnBack and OnCancel events of the web page. The use of a script ensures that the operation of the WWE is independent of any Operating System. These events provide navigational support in a similar manner to the component based back-button and next-button. Furthermore, WWE initiates some additional object model functions upon creation, namely FinalNext, FinalBack, Cancel and SetHeaderText, which provide the means for communication to the HTML pages. FinalNext signals the need to navigate to the next sequential page of the host-wizard from the WWE pages. Conversely, FinalBack signals the need to navigate to the most recent host page preceding the WWE pages and the need to pass control back to the host-wizard program. Cancel provides a way to exit WWE and the host wizard application. Finally, SetHeaderText allows the host wizard to set or manipulate the content of the header display are of the WWE screen.

In addition to all of the features of the various extensions discussed thus far, there is the ability to pass a ‘property bag’ between a host wizard and a wizard extension regardless of whether the extension is an object component or a Web component. For example, the Property function of WWE, allows scripts running on HTML pages to access properties from a ‘property bag’ that was passed from a host wizard. In other words, the present invention facilitates the exchange of various types of information between a host and a wizard extension in an extensible manner. The nature of the ‘property bag’ is such that there is no limitation to the number or data type of the parameters that can be exchanged.

As would be understood by those skilled in the art of the present invention the it process described above along with the objects specified such as, navigation buttons, screens, program/class objects and so on, are merely exemplary and are not intended to limit the scope of the present invention. Accordingly, the scope of the present invention is defined by the appended claims rather than the foregoing description.

We claim:

1. A method for use in a computing environment for extending a wizard comprising:
providing a host-wizard component;
providing one or more sub-wizard components; and
said host-wizard invoking said one or more sub components during said host component execution.

2. A method as recited in claim 1 wherein said one or more sub-wizard components is a browser based object component.

3. A method as recited in claim 1 wherein said one or more sub-wizard components is an operating system based application component object extension.

4. A system for use in a computing environment for extending a wizard comprising:
a host wizard, said host-wizard having an interface adapted to communicate with other wizards and a host navigational component adapted to transfer control to other wizards;
one or more sub-wizard components, said one or more sub-wizard component having a sub-wizard interface adapted to communicate with other wizards and a sub-wizard navigational component adapted to transfer control to other wizards;
wherein said host-wizard can communicate with said one or more sub-wizard components through said host-wizard interface and at least one of said sub-wizard interfaces; and
wherein control between said host-wizard and said one or more sub-wizard components can be transferred to one another through said host navigational component and said sub-wizard navigational component to create an extended wizard.

5. A system as recited in claim 4 wherein said one or more sub-wizards is a browser based object component.

6. A system as recited in claim 4 wherein said one or more sub-wizards is a component object extension.

7. A method for use in a computing environment for extending a wizard comprising:
providing a host wizard;
providing a web component comprising:
a web page, said web page containing a header area, a wizard control area and a control interface area;
one or more object module functions, said object module functions enabling navigation; and
said control interface area having navigation control means for recursive navigation within said web component and to said host wizard, by utilizing said one or more object module functions;
providing a user interface that integrates said web component into said host wizard; and
providing an information container to exchange informational items between said web component and said host wizard.

8. A computer readable medium having computer executable instructions for performing a method for use in a computing environment for extending a wizard comprising:
providing a host-wizard component;
providing one or more sub-wizard components; and
said host component capable of invoking said one or more sub components during said host-wizard component execution.

9. A computer system having a processor, a memory and an operating environment, the computer system operable to execute a method for use in a computing environment for extending a wizard comprising:
providing a host-wizard component;
providing one or more sub-wizard components; and
said host component invoking said one or more sub components during said host-wizard component execution.

10. A computer readable medium having computer executable instructions for performing a method for use in a computing environment for extending a wizard comprising:
providing a host wizard;
providing a web component comprising:
a web page, said web page containing a header area, a wizard control area and a control interface area;
one or more object module functions, said object module functions enabling navigation; and
said control interface area having navigation control means for recursive navigation within said web component and to said host wizard, by utilizing said one or more object module functions;
providing a user interface that integrates said web component into said host wizard; and
providing an information container to exchange informational items between said web component and said host wizard.

11. A computer system having a processor, a memory and an operating environment, the computer system operable to execute a method for use in a computing environment for extending a wizard comprising:
providing a host wizard;
providing a web component comprising:
a web page, said web page containing a header area, a wizard control area and a control interface area;
one or more object module functions, said object module functions enabling navigation; and
said control interface area having navigation control means for recursive navigation within said web component and to said host wizard, by utilizing said one or more object module functions;
providing a user interface that integrates said web component into said host wizard; and
providing an information container to exchange informational items between said web component and said host wizard.

12. A method for use in a computing environment for chaining wizards comprising:
providing a first wizard;
providing a second wizard; and
providing at least one navigation component on each of said first and second wizards, said navigation components allowing sequential progression or regression through said first and second wizards to chain said second wizard to said first wizard.

13. A method as recited in claim 12, wherein said first wizard is selected from the group consisting of an operating system based wizard and a web based wizard; and
said second wizard is selected from the group consisting of an operating system based wizard and a web based wizard.

14. A computer system having a processor, a memory and an operating environment, the computer system operable to execute a method for use in a computing environment for chaining wizards comprising:
providing a first wizard;
providing a second wizard; and
providing at least one navigation component on each of said first and second wizards, said navigation components allowing sequential progression or regression through said first and second wizards to chain said second wizard to said first wizard.

15. A computer readable medium having computer executable instructions for performing a method for use in a computing environment for chaining wizards comprising:
providing a first wizard;
providing a second wizard; and
providing at least one navigation component on each of said first and second wizards, said navigation components allowing sequential progression or regression through said first and second wizards to chain said second wizard to said first wizard.
